(19) United States
(12) Patent Application Publication
(10) Pub. No.: US 2026/0235895 A1
(43) Pub. Date: Aug. 13, 2026

(54) Semiconductor Optical Modulator

(71) Applicant: NTT, Inc., Tokyo (JP)

(72) Inventors: Josuke Ozaki, Musashino-shi, Tokyo (JP); Yasuaki Hashizume, Musashino-shi, Tokyo (JP); Nobuhiro Nunoya, Musashino-shi, Tokyo (JP)

(21) Appl. No.: 19/154,706

(22) PCT Filed: Feb. 9, 2023
(86) PCT No.: PCT/JP2023/004435

§ 371 Date: Aug. 7, 2025

(51) Int. Cl. G02F 1/025; G02F 1/01; G02F 1/21

(52) U.S. Cl. CPC G02F 1/025; G02F 1/0147; G02F 1/212

(57) ABSTRACT

A semiconductor optical modulator according to the present disclosure including an optical waveguide having a structure in which a lower cladding layer formed of at least one or more of an n-type semiconductor or a p-type semiconductor, a core layer formed of a non-doped semiconductor including an MQW layer, and an upper cladding layer formed of at least one or more of an n-type semiconductor or a p-type semiconductor are epitaxially grown in order on a semiconductor substrate, and a phase modulation unit that performs phase modulation of light propagating through the optical waveguide, in which the phase modulation unit includes a heater mechanism that heats the optical waveguide and an RF electrode connected to the optical waveguide, the optical waveguide has a ridge structure, and the heater mechanism is formed on the core layer of the optical waveguide.

### TECHNICAL FIELD

The present disclosure relates to a semiconductor optical modulator.

### BACKGROUND ART

In an optical fiber communication system in recent years, a backbone network transmission technology of 100 Gbps per wavelength has been established by introduction of digital signal processing technology including digital coherent. At present, this backbone network transmission technology has increased in speed from 400 Gbps to 600 Gbps per wavelength, and is reaching a level of practical use.

In a communication system exceeding 400 Gbps, analog components are required to have a wider bandwidth (for example, the modulation band is 40 GHz or more), and thus, a form in which an RF driver (driver IC) and an optical modulator are integrally packaged and mounted has attracted attention on a transmission side for the purpose of reduction of a loss of a high frequency (radio frequency: hereinafter, also referred to as RF) and miniaturization. Transmitters using such a mounting form are standardized in the Optical Internetworking Forum (OIF) under the name of High-Bandwidth Coherent Driver Modulator (HB-CDM) (see, for example, Non Patent Literature 1). In addition, an indium phosphide (InP) modulator is mainly used in the HB-CDM (see, for example, Non Patent Literature 2).

In recent years, in an optical transmission device, instead of a conventional lithium niobate (LN) optical modulator, semiconductor-based optical modulators have attracted attention from the viewpoint of miniaturization and cost reduction of the device. In particular, a compound semiconductor represented by InP is mainly used for a further high-speed modulation operation, and research and development are focused on a silicon (Si)-based optical device in a system in which more miniaturization and cost reduction are regarded as important.

There are advantages and disadvantages inherent to materials also in semiconductor optical modulators. For example, an InP modulator is excellent in high-speed modulation operation, but it is considered that temperature control of an optical modulator chip is essential during the modulation operation to control a band edge absorption effect. On the other hand, an LN modulator and a Si modulator have a merit that temperature control is not necessary, which is considered to be advantageous for low-power consumption.

When modularizing the InP modulator, the optical modulator chip is necessary to be mounted on a Peltier element for temperature control, which may contribute to an increase in power consumption. In addition, there is also a problem that miniaturization of the package size cannot be achieved due to an arrangement of the Peltier element. Therefore, when the Peltier element can be made unnecessary or an area in which the Peltier element is disposed can be reduced, a high-speed, low-power consumption, and low-height optical module on which an InP modulator excellent in high-speed modulation operation is mounted can be achieved.

In addition, since the InP modulator uses the band edge absorption effect, it is essential to change an epi structure (control of absorption by PL wavelength or the like) between for the C band and for the L band, and there is also a problem that it is difficult to share the chip between the C band and the L band.

### CITATION LIST

### Non Patent Literature

Non Patent Literature 1: Implementation Agreement for the High Bandwidth Coherent Driver Modulator (HB-CDM), OIF-HB-CDM-02.0 (2021)https://www.oiforum.com/wp-content/uploads/OIF-HB-CDM-02.0.pdf Non Patent Literature 2: J. Ozaki, Y. Ogiso, Y. Hashizume, H. Yamazaki, K. Nagashima and M. Ishikawa, “Coherent Driver Modulator With Flexible Printed Circuit RF Interface for 128-Gbaud Operations”, IEEE Photonics Technology Letters, vol. 34, No. 23, pp. 1289-1292 (2022) doi: 10.1109/LPT.2022.3212678.

### SUMMARY OF INVENTION

The present disclosure has been made in view of the above problems, and an object of the present disclosure is to provide a semiconductor optical modulator that can cope with a wider operating wavelength band (for example, the C +L band) than a semiconductor optical modulator according to the related art.

To solve the problems as described above, the present disclosure provides a semiconductor optical modulator including an optical waveguide having a structure in which a lower cladding layer formed of at least one or more of an n-type semiconductor or a p-type semiconductor, a core layer formed of a non-doped semiconductor including an MQW layer, and an upper cladding layer formed of at least one or more of an n-type semiconductor or a p-type semiconductor are epitaxially grown in order on a semiconductor substrate, and a phase modulation unit that performs phase modulation of light propagating through the optical waveguide, in which the phase modulation unit includes a heater mechanism that heats the optical waveguide and an RF electrode connected to the optical waveguide, the optical waveguide has a ridge structure, and the heater mechanism is formed on the core layer of the optical waveguide.

### BRIEF DESCRIPTION OF DRAWINGS

FIG. 1(a) to 1(c) are views each illustrating a structure of an InP modulator 100 according to a first embodiment of the present disclosure. FIG. 1(a) illustrates a top view. FIG. 1(b) illustrates a cross-sectional view taken along a cross-sectional line Ib-Ib. FIG. 1(c) illustrates a cross-sectional view taken along a cross-sectional line Ic-Ic.

FIG. 2(a) to 2(d) are cross-sectional views in a width direction each illustrating a form in which an arrangement of heater mechanisms 108 is different as another form of the InP modulator 100 according to the first embodiment of the present disclosure. FIG. 2(a) illustrates a cross-sectional view taken along the cross-sectional line Ib-Ib in FIG. 1 in a case where the InP optical waveguide 102 has a ridge structure. FIG. 2(b) illustrates a cross-sectional view taken along the cross-sectional line Ic-Ic in FIG. 1 in a case where the InP optical waveguide 102 has the ridge structure. FIG. 2(c) illustrates a cross-sectional view taken along the cross-sectional line Ib-Ib in FIG. 1 in a case where the InP optical waveguide 102 has a high-mesa structure. FIG. 2(d) illustrates a cross-sectional view taken along the cross-sectional line Ic-Ic in FIG. 1 in a case where the InP optical waveguide 102 has the high-mesa structure.

FIG. 3(a) and 3(b) are cross-sectional views in a width direction each illustrating another form of the InP modulator 100 according to the first embodiment of the present disclosure. FIG. 3(a) illustrates a cross-sectional view taken along the cross-sectional line Ib-Ib in FIG. 1. FIG. 3(b) illustrates a cross-sectional view taken along the cross-sectional line Ic-Ic in FIG. 1.

FIG. 4(a) and 4(b) are cross-sectional views in a width direction each illustrating another form of the InP modulator 100 according to the first embodiment of the present disclosure. FIG. 4(a) illustrates a cross-sectional view taken along the cross-sectional line Ib-Ib in FIG. 1. FIG. 4(b) illustrates a cross-sectional view taken along the cross-sectional line Ic-Ic in FIG. 1.

FIG. 5(a) and 5(b) are cross-sectional views taken along the cross-sectional line Ib-Ib in FIG. 1, each illustrating another form of the InP modulator 100 according to the first embodiment of the present disclosure. FIG. 5(a) illustrates a form in which the heater mechanisms 108 are installed on n-InP 102a. FIG. 5(b) illustrates a form in which one of the heater mechanisms 108 is disposed on the n-InP 102a and the other is disposed on a substrate 110.

FIG. 6(a) and 6(b) are longitudinal cross-sectional views each illustrating a structure of an InP modulation device 600 according to a second embodiment of the present disclosure. FIG. 6(a) illustrates a structure not including a carrier 603. FIG. 6(b) illustrates a structure including the carrier 603.

### DESCRIPTION OF EMBODIMENTS

Hereinafter, various embodiments of the present disclosure are described in detail with reference to the drawings. The same or similar reference signs denote the same or similar components, and redundant description is omitted in some cases. The materials and numerical values are for illustrative purposes and are not intended to limit the scope of the disclosure. The following description is an example, and some configurations may be omitted, modified, or implemented together with additional configurations without departing from the gist of an embodiment of the present disclosure.

### First Embodiment

Hereinafter, a first embodiment of the present disclosure is described in detail with reference to the drawings. Hereinafter, a single Mach-Zehnder modulator is described as an example, but an IQ modulator, a Twin-IQ modulator, or the like in which a plurality of the Mach-Zehnder modulators is arranged may be used. In the following description, the InP modulator is taken as an example, but semiconductor optical modulators of other material systems such as GaAs may be used.

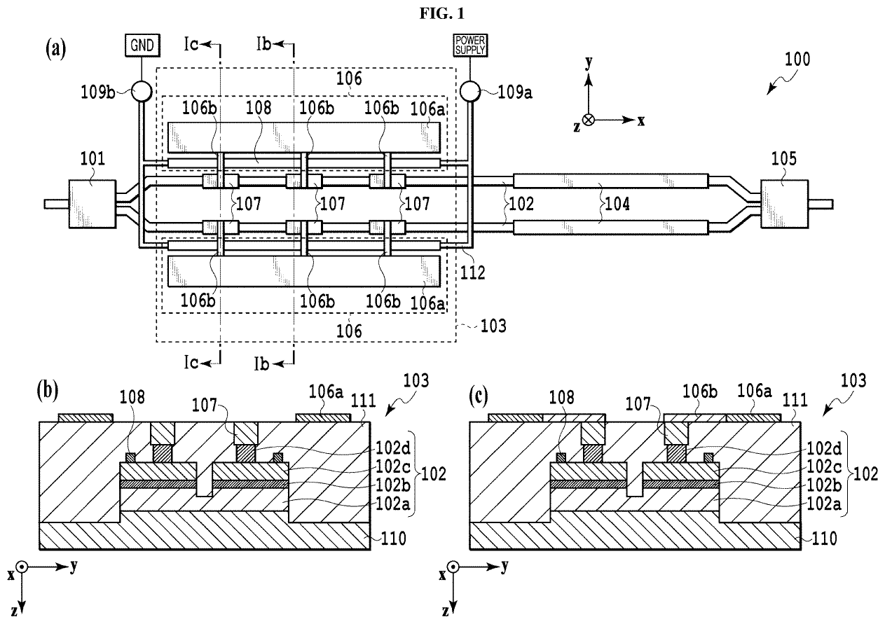

FIG. 1(a) to 1(c) are views each illustrating a structure of an InP modulator 100 according to the first embodiment of the present disclosure. FIG. 1(a) illustrates a top view. FIG. 1(b) illustrates a cross-sectional view taken along a cross-sectional line Ib-Ib. FIG. 1(c) illustrates a cross-sectional view taken along a cross-sectional line Ic-Ic. As illustrated in FIG. 1, the InP modulator 100 includes a 1-input 2-outputs (1×2) multimode interference waveguide (MultiMode-Interferometer: hereinafter referred to as MMI) 101, InP optical waveguides 102 through which light branched by the MMI 101 propagates, a phase modulation unit 103 that performs phase modulation of the propagating light, phase adjustment electrodes 104 that are installed on an output side of the phase modulation unit 103 and perform phase adjustment of phase modulated light, and a 2×1 MMI 105 that is installed on an output side of the phase adjustment electrodes 104 and multiplexes the branched light to output to the outside. As illustrated in FIG. 1, the InP modulator 100 is a Mach-Zehnder type optical modulator.

As illustrated in FIG. 1(a) and 1(b), the phase modulation unit 103 further includes the substrate 110, the optical waveguides 102 formed on the substrate 110, RF phase modulation electrodes 106 each functioning as an electrode of an RF to be applied, RF electrodes 107 each serving as an electrode for applying a high frequency supplied from the RF phase modulation electrode 106 to the optical waveguide 102, heater mechanisms 108 each heating the optical waveguide 102, and a dielectric layer 111 formed on the substrate 110 and covering the periphery of the optical waveguides 102 and the heater mechanisms 108. The heater mechanisms 108 are connected to metal wirings 112, and the metal wirings 112 are integrated into one by PADs 109a and 109b and connected to an external power supply and GND. Note that, although FIG. 1 illustrates a form including the metal wiring 112, a portion of the metal wiring 112 may also be a metal wiring equivalent to the heater mechanism 108, or may be a completely different metal wiring. In FIG. 1, the heater mechanism 108 is illustrated to be thicker and the metal wiring 112 is illustrated to be thinner, but the heater mechanism 108 may be thinner and the metal wiring 112 may be thicker.

The optical waveguide 102 has an n-i-p-n heterostructure in which a first cladding layer 102a formed of at least one or more of an n-type semiconductor layer formed on a substrate, a second cladding layer 102b formed of at least one or more of a p-type semiconductor layer formed on the first cladding layer 102a, a non-doped semiconductor core layer 102c formed on the second cladding layer 102b, and a third cladding layer 102d formed of at least one or more of an n-type semiconductor layer formed on the semiconductor core layer 102c are epitaxially grown. The semiconductor core layer 102c includes, for example, a multi quantum well (hereinafter, referred to as MQW) layer using a material system such as InP, InGaAsP, or InGaAlAs, which are non-doped. A band gap wavelength of the MQW layer is optionally set within a range in which an electro-optical effect effectively acts and light absorption does not cause a problem in an optical wavelength to be used. Here, the semiconductor core layer 102c functions as a core through which light propagates. In such an n-i-p-n heterostructure, since the p layer having a large influence on the high frequency loss can be thinned and a contact surface with the RF electrode 107, which is a metal, can be an n layer, the high frequency loss can be greatly reduced as compared with the conventional pin layer structure. However, this is for the purpose of illustration, and the optical waveguide 102 may have a pin layer structure.

The RF phase modulation electrode 106 has a capacitance-loaded structure and includes a main line portion 106a and T-shaped portions 106b periodically branched from the main line portion 106a for applying a modulation signal to the InP optical waveguide 102. The InP modulator 100 has a structure in which the T-shaped portion 106b adds capacitance, and thus is referred to as a capacitance-loaded type. In FIG. 1, for the sake of simplicity, only three T-shaped portions 106b are drawn, but this is for the purpose of illustration, and three or more T-shaped portions 106b may be arranged or three or less may be arranged. In addition, in the present embodiment, the capacitance-loaded structure is illustrated as an example, but the present patent structure is also effective other than the capacitance-loaded structure.

The heater mechanism 108 supplies heat to (heats) the MQW that constitutes the non-doped semiconductor core layer 102c of the InP modulator 100 and contributes to the phase modulation. With such a configuration, a mechanism that can control the temperature of the MQW can be provided without using the Peltier element. By controlling the temperature of the MQW with the heater mechanism 108, an amount of a refractive index effect based on the light absorption and the quantum confined Stark effect (QCSE) of the MQW can be appropriately adjusted. For example, when the temperature of the MQW increases, the band edge shifts to a longer wavelength side, and thus a state suitable for an operation on the longer wavelength side is obtained. The heater mechanism 108 may typically be a metal. Therefore, when the heater mechanism 108 is disposed immediately below the main line portion 106a in the thickness direction (z direction), high-frequency electromagnetic field distributions of the RF phase modulation electrode 106 and the RF electrode 107 are affected, and as a result, the high-frequency characteristics of the InP modulator 100 may be deteriorated. Therefore, the heater mechanism 108 is desirably disposed so as to be provided with a distance (for example, as illustrated in FIG. 1(a) and 1(b), so as to be located between the main line portion 106a and the RF electrode 107 in the width direction (y direction)) from the RF phase modulation electrode 106 and the RF electrode 107 to the extent that the heater mechanism 108 does not interfere (does not affect each of the high-frequency electromagnetic field distributions) and so as to be parallel to the longitudinal direction (x direction) of the RF phase modulation electrode 106 and the RF electrode 107. Since the heater mechanism 108 is necessary to heat the entire MQW layer of a portion contributing to the phase modulation, the length of the heater mechanism 108 in the x direction is desirably equal to or greater than the length of the RF phase modulation electrode 106 in the x direction. A resistance value of the heater mechanism 108 may be optionally set according to the design. For example, the resistance of the heater mechanism 108 may be set higher only in a peripheral region where the RF electrode 107 connected to the T-shaped portion 106b is installed than in other regions. However, since the optical modulator is necessary to have a desired calorific value, the resistance value of the heater mechanism 108 is desirably at least 300 2 or more.

The heater mechanism 108 is desirably configured to uniformly heat each of branched arms of the optical waveguide 102. Therefore, the heater mechanism 108 is provided for each of the branched optical waveguides 102. Furthermore, to supply equivalent heat to each of the branched optical waveguides 102, the heater mechanisms 108 are desirably connected to a power supply (voltage source or current source) and GND after being integrated into one PAD 109a and one PAD 109b. For example, when the InP modulator 100 is a Twin-IQ modulator or the like, four Mach-Zehnder modulators are integrated, so that eight heater mechanisms 108 are necessary. When such a twin-IQ modulator is used for the HB-CDM, the number of PADs and pins required may increase, and control may also be difficult. Therefore, all the eight heater mechanisms 108 are desirably integrated into the same PADs 109a and 109b. Note that the shapes of the PADs 109a and 109b are drawn as circular shapes in FIG. 1, but this is for the purpose of illustration, and the shapes may be, for example, square shapes.

In the phase modulation unit 103, from the viewpoint of directly heating the semiconductor core layer 102c, the structure of the optical waveguide 102 is desirably a ridge structure. The structure may be a high-mesa structure, but in such a case, the width (length in the y direction) of the optical waveguide 102 is processed to be the same as the width of the third cladding layer 102d, so that the heater mechanism 108 cannot be installed on the semiconductor core layer 102c. Therefore, in a case where the optical waveguide 102 has the high-mesa structure, the heater mechanism 108 is necessary to be arranged at another position (for example, on the substrate 110) as described later, and accordingly, the heating efficiency of the semiconductor core layer 102c decreases. On the other hand, when the structure of the optical waveguide 102 is the ridge structure, the heater mechanism 108 can be installed on the semiconductor core layer 102c, so that the semiconductor core layer 102c can be directly heated. From such a viewpoint, it can be said that the ridge structure is more effective than the high-mesa structure in the structure of the optical waveguide 102. However, even when the heater mechanism 108 is installed at another position (for example, on the substrate 110), heating of the semiconductor core layer 102c itself can be performed, so that the heater mechanism 108 is not necessarily installed on the semiconductor core layer 102c.

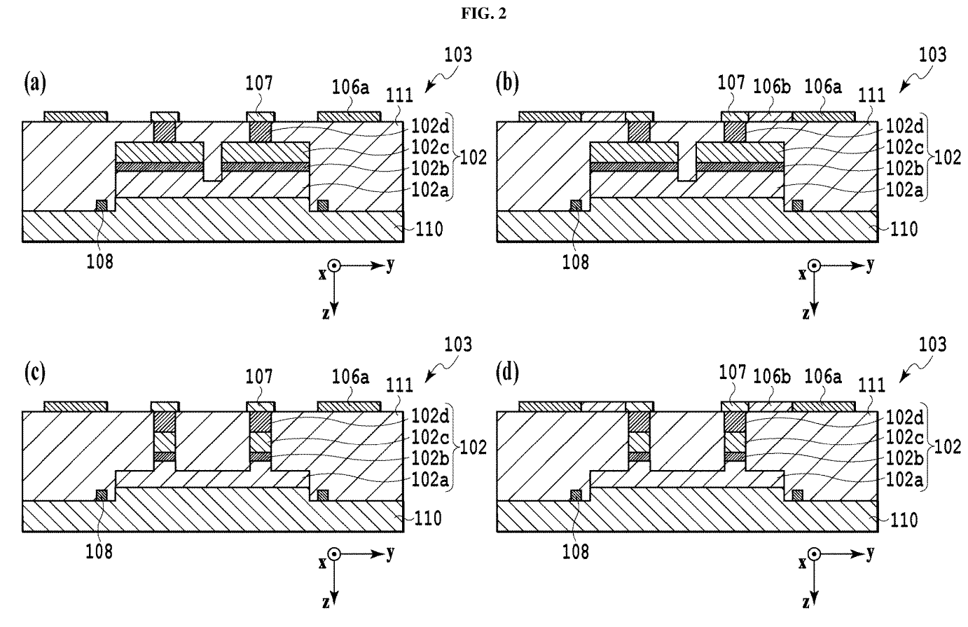

FIG. 2(a) to 2(d) are cross-sectional views in a width direction each illustrating a form in which an arrangement of heater mechanisms 108 is different as another form of the InP modulator 100 according to the first embodiment of the present disclosure. FIG. 2(a) illustrates a cross-sectional view taken along the cross-sectional line Ib-Ib in FIG. 1 in a case where the optical waveguide 102 has a ridge structure. FIG. 2(b) illustrates a cross-sectional view taken along the cross-sectional line Ic-Ic in FIG. 1 in a case where the InP optical waveguide 102 has the ridge structure. FIG. 2(c) illustrates a cross-sectional view taken along the cross-sectional line Ib-Ib in FIG. 1 in a case where the optical waveguide 102 has a high-mesa structure. FIG. 2(d) illustrates a cross-sectional view taken along the cross-sectional line Ic-Ic in FIG. 1 in a case where the optical waveguide 102 has the high-mesa structure. As illustrated in FIG. 2, in the InP modulator 100, the heater mechanism 108 may be disposed on the substrate 110. With such a form, the structure of the optical waveguide 102 may be the ridge structure or the high-mesa structure. As described above, in the form in which the heater mechanism 108 is disposed on the substrate 110, the efficiency decreases as compared with the form illustrated in FIG. 1 from the viewpoint of heating the semiconductor core layer 102c including the MQW. However, such an embodiment has a feature that degradation of the high-frequency characteristics can be suppressed since the distance between the heater mechanism 108, and the RF phase modulation electrode 106 and the RF electrode 107 is larger than the form illustrated in FIG. 1.

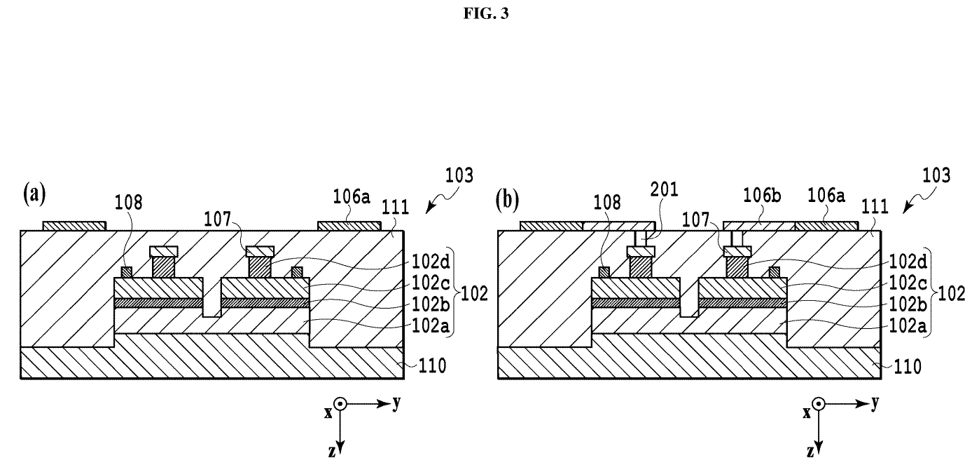

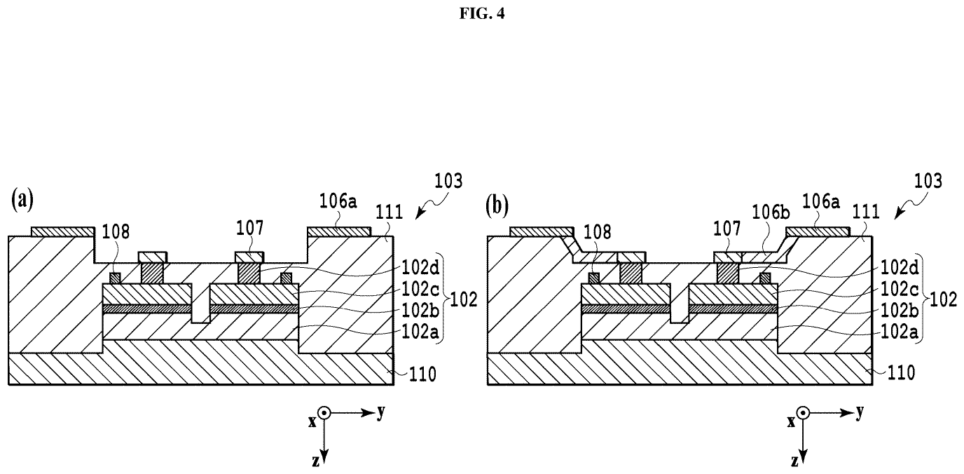

As described above, when the distance between the heater mechanism 108, and the RF phase modulation electrode 106 and the RF electrode 107 is short, the heater mechanism 108, which is typically a metal, affects the high-frequency electromagnetic field distributions of the RF phase modulation electrode 106 and the RF electrode 107, and as a result, the high-frequency characteristics of the InP modulator 100 may be deteriorated. From such a viewpoint, in the InP modulator 100 according to the present disclosure, the heater mechanism 108 and the RF phase modulation electrode 106 are desirably arranged so that a distance between them is as long (separated) as possible. For example, in a form in which the heater mechanism 108 is installed on the substrate 110 as illustrated in FIG. 2, the distance between the RF phase modulation electrode 106, and the RF electrode 107 and the heater mechanism 108 in the thickness direction (z direction) can be increased by thickening the dielectric layer 111. As another example, as illustrated in FIG. 3, a via 201 may be provided between the T-shaped portion 106b and the RF electrode 107. Furthermore, in a case where the RF electrode 107 is embedded in the dielectric layer 111 as illustrated in FIG. 3, the RF electrode 107 may be configured to be a thick film to increase the distance between the RF phase modulation electrode 106 and the heater mechanism 108 in the thickness direction. With such a configuration, the via 201 can be made unnecessary. As still another example, as illustrated in FIG. 4, only a region corresponding to the upper portion of the optical waveguide 102 in the dielectric layer 111 may be thinned (in other words, the dielectric layer 111 is thickened only in the region where the main line portion 106a is disposed). However, in the case of a form as illustrated in FIG. 4, the distance between the T-shaped portion 106b and the heater mechanism 108 may be partially short.

In addition, the above-described degradation of the high-frequency characteristics may be suppressed by controlling the arrangement or dimension of the heater mechanism 108. For example, the influence of the heater mechanism 108 on the high-frequency electromagnetic field distribution of the RF phase modulation electrode 106 can be suppressed by narrowing the diameter (a plane perpendicular to the xy plane) of the heater mechanism 108. The width (length in the y direction) of the heater mechanism 108 is desirably 1 μm or less, and when the width can be set to 0.1 μm or less, the influence on the high-frequency characteristics can be almost ignored. However, in a case where the diameter is extremely narrowed, disconnection at the time of heating may occur, and thus, it is necessary to secure the dimension of the diameter so that the disconnection does not occur. In addition, distances between the main line portion 106a and the heater mechanism 108 in the thickness direction (z direction) and in the width direction (y direction) are desirably at least 5 μm or more. In consideration of such a viewpoint, the diameter of the heater mechanism 108 is desirably, for example, 1 μm or less in both thickness and width.

On the other hand, from the viewpoint that the heater mechanism 108 is necessary to achieve heat generation from about 40° C. to about 60° C. or more in which a typical InP modulator is temperature controlled by the Peltier element, the heater mechanism 108 desirably has a calorific value of at least about 100° C. Therefore, for example, the heater mechanism 108 desirably has a resistance value of at least 300 Ω or more. As an additional example, from the viewpoint of efficiently supplying the temperature to the semiconductor core layer 102c, to suppress the release of heat to the lower portion of the semiconductor core layer 102c, the third cladding layer 102b may be set to have a thermal resistance higher than that of the semiconductor core layer 102c.

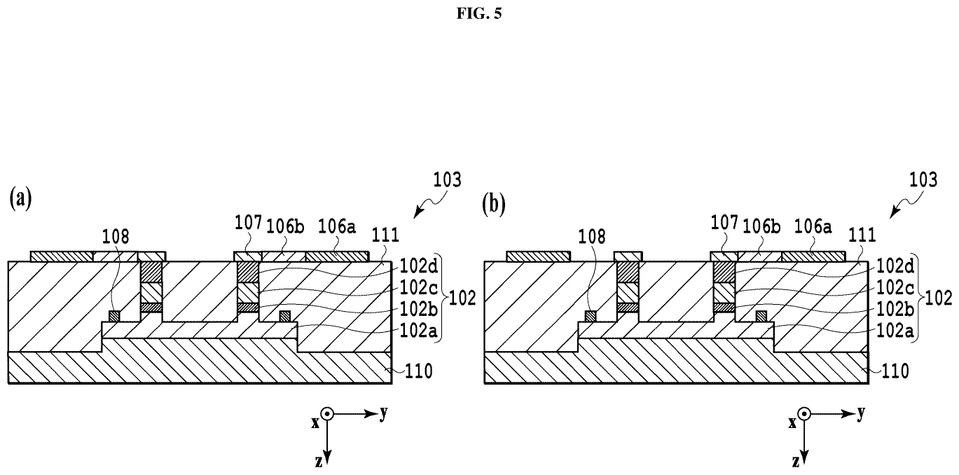

The heater mechanisms 108 may be installed on the first cladding layer 102a as illustrated in FIG. 5. Further, the heater mechanisms 108 may be installed at different positions, for example, one on the first cladding layer 102a and the other on the substrate 110.

In the InP modulator 100 according to the present embodiment configured as described above, the operating wavelength range of the InP modulator can be widened by controlling the calorific value of the heater mechanism 108 by either a current or a voltage according to the operating wavelength. In general, the InP modulator uses the refractive index effect due to a change in band edge absorption referred to as QCSE. Generally, a photosemiconductor has a characteristic that a light absorption amount is large on a short wavelength side and small on a long wavelength side. Therefore, when the photosemiconductor is used in a wide wavelength band, an event in which the modulation efficiency is lowered occurs on the long wavelength side, and it is necessary to separately change the PL wavelength of the MQW layer in the modulator for the C band operation and the modulator for the L band operation (for example, in the InP modulator according to the related art, it is necessary to make the PL wavelength longer in the L band than in the C band). On the other hand, in the InP modulator 100 according to the present embodiment, for example, under the same temperature, the calorific value of the heater mechanism 108 is further increased at the time of operation on the long wavelength side to increase the temperature of the MQW and shift the band edge to the long wavelength side, and the calorific value is decreased on the short wavelength side to decrease the temperature of the MQW and decrease the amount of shift of the band edge to the long wavelength side. As described above, by adjusting the amount of change in the band edge according to the wavelength, an InP modulator that can operate in the C band and the L band, which has not been provided before, can be provided. As described later, similarly, in a case where the InP modulator is mounted on the Peltier element, a similar effect can be also obtained by changing the temperature of the Peltier element according to the wavelength.

In the InP modulator 100 according to the present embodiment, the temperature of the semiconductor core layer including the MQW layer can be controlled by the heater mechanism 108. Therefore, the Peltier element in the related art can be made unnecessary, and miniaturization and low-power consumption of the optical module using the InP modulator 100 according to the present embodiment can be achieved. On the other hand, a combination can be used in which the Peltier element is used while having this structure (details are described in a second embodiment described later).

Furthermore, in a form in which a driver is mounted adjacently to the extent that the driver is affected by heat from the heater mechanism of the modulator as in the HB-CDM, in a case where a driver IC includes a temperature monitoring mechanism, a relative value of the i-InP 102c (MQW) temperature can be calculated by using the temperature monitoring mechanism of the driver IC. Therefore, control can be performed such that the heater mechanism 108 performs heating to a desired temperature using the temperature as a monitored value. For example, in the case of operating at the same wavelength, the control can be performed such that heating of the heater mechanism 108 is suppressed when a monitor temperature of the driver is high, and heating of the heater is promoted when the monitor temperature is low.

Note that, in a case where the InP modulator 100 according to the present embodiment described above is used for the HB-CDM, the range of the operating temperature of the phase modulation unit 103 is desirably set in a range different from that of the semiconductor optical modulator according to the related art. Typically, in the HB-CDM, it is required to operate at least at an environmental temperature from −5° C. to 75° C. On the other hand, the heater mechanism 108 can only perform heating and cannot perform cooling. Therefore, for example, considering any one wavelength, the temperature of the semiconductor core layer 102c (MQW) is necessary to be controlled to be constant by the heater mechanism 108 in a range of the environmental temperature from −5° C. to 75° C. Therefore, specifically, the operating temperature of the InP modulator 100 is necessary to be controlled to 75° C. or higher of the environmental temperature by the heater mechanism 108. In the semiconductor optical modulator according to the related art, the temperature is controlled by the Peltier element in a range from about 40° C. to about 60° C. However, when an appropriate operating temperature of the InP modulator 100 according to the present embodiment is set from 40° C. to 60° C. similarly to the related art, cooling cannot be performed when the environmental temperature reaches 75° C., and a problem arises in that a desired temperature cannot be achieved. Therefore, to maintain the temperature of the semiconductor core layer 102c (MQW) within an appropriate range under the environmental temperature from −5° C. to 75° C. in an operation of any one wavelength, at least the InP modulator 100 according to the present embodiment is necessary to be designed such that an appropriate operation can be performed at 75° C. or higher. In consideration of the power consumption and stable operation of the heater mechanism 108, the appropriate temperature is desirably set so as to be kept within about the maximum environmental temperature +10° C.

### Second Embodiment

Hereinafter, a second embodiment of the present disclosure is described in detail with reference to the drawings. The present embodiment relates to an InP modulation device including the InP modulator 100 and the Peltier element described in the first embodiment.

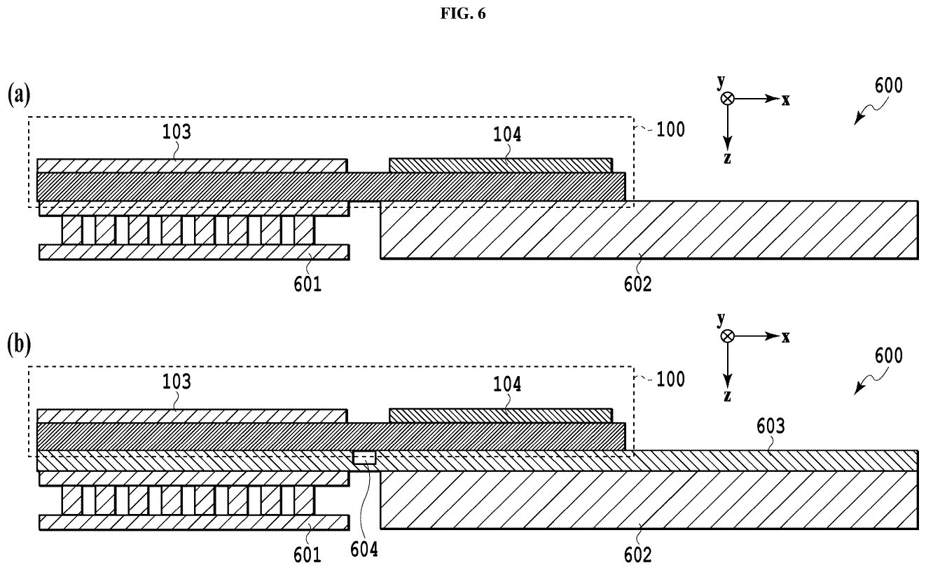

FIG. 6(a) and 6(b) are longitudinal cross-sectional views each illustrating a structure of an InP modulation device 600 according to the second embodiment of the present disclosure. FIG. 6(a) illustrates a structure not including a carrier 603. FIG. 6(b) illustrates a structure including the carrier 603. As illustrated in FIG. 6, the InP modulation device 600 according to the present embodiment has a structure in which the InP modulator 100 according to the first embodiment is placed on a Peltier element 601 and a dielectric substrate 602. As illustrated in FIG. 6(b), the InP modulation device 600 may further include a carrier 603 on the Peltier element 601 and the dielectric substrate 602 and below the InP modulator 100.

To apply heat most efficiently (to suppress the power consumption of the Peltier element as much as possible), as illustrated in FIG. 6, the Peltier element 601 is desirably installed such that only the phase modulation unit 103 is placed on the Peltier element 601. More optimally, it is optimal to provide the Peltier element only in a lower portion of a phase modulation arm. However, this example is merely an example, and the entire chip may be mounted on the Peltier element 601. In that case, since an extra heater mechanism is provided as compared with a typical modulator, the power consumption increases as a result. This is because the power consumption of the Peltier depends on the area of the Peltier. Therefore, in consideration of an increase in the power consumption of the Peltier element due to heat generated by the heater mechanism, it is necessary to make the size of the Peltier element very small to achieve conventional power consumption in the optical modulator including the heater mechanism.

The dielectric substrate 602 is not necessarily included in the InP modulation device 600, but is desirably installed from the viewpoint of securing a region where an optical mounting member (not illustrated) such as a lens is mounted. The dielectric substrate 602 may use ceramics such as aluminum nitride (AIN) having excellent heat dissipation or a metal.

The carrier 603 desirably further includes a thermal separation groove 604 from the viewpoint of thermal separation between the RF phase modulation electrode 106 and the phase adjustment electrode 104. This is because, for example, the phase adjustment electrode 104 is generally constituted by a heater in the InP modulator, and in this case, the heat of the heater of the phase adjustment electrode 104 flows into the Peltier element 601, and the power consumption of the Peltier element 601 increases. Further, the carrier 603 may have a form overhanging from the Peltier element 601, or an additional component (for example, the dielectric substrate 602) may be installed at a lower portion of the carrier 603. In addition, the carrier 603 may include a step (not illustrated) as necessary only in a region where an optical mounting member such as a lens is mounted.

Since the InP modulation device 600 having such a configuration includes the Peltier element 601, by controlling the temperature of the Peltier element 601 according to the wavelength, the operating wavelength range can be widened similarly to the effect of the heater mechanism 108 of the InP modulator 100. In the InP modulation device 600 according to the present embodiment, the Peltier element 601 is installed only in a region corresponding to the RF phase modulation electrode 106. Therefore, the area occupied by the Peltier element 601 can be reduced as compared with a case where the entire InP modulation device 600 is placed on the Peltier element, and the power consumption can be suppressed.

On the other hand, in the conventional InP modulator, since the temperature of the Peltier element is not switched for each wavelength, the operation as described above is highly likely to be difficult. In this case, the operation is performed with the set temperature of the Peltier element being constant. In this case, the amount of heat controlled for each operating wavelength is applied to only the portion in a pinpoint manner by the heater mechanism 108 having the same configuration as that of the first embodiment, so that the operating wavelength can be widened to achieve a C+L band operation and the like. However, in a case where the Peltier element 601 can switch the temperature for each wavelength, the operating wavelength can be widened without using the heater mechanism 108.

### Industrial Applicability

As described above, the semiconductor optical modulator (InP modulator) according to the present disclosure can widen the wavelength operating range as compared with the related art. Such a semiconductor optical modulator is expected to be applied to a device for an optical fiber communication system such as the HB-CDM as an optical modulator that can be applied to a wider band than the related art.

1.-8. (canceled)

9. A semiconductor optical modulator comprising:
an optical waveguide having a structure that a lower cladding layer formed of at least one or more of an n-type semiconductor or a p-type semiconductor, a core layer formed of a non-doped semiconductor including an MQW layer, and an upper cladding layer formed of at least one or more of an n-type semiconductor or a p-type semiconductor are epitaxially grown in order on a semiconductor substrate; and
a phase modulation unit configured to perform phase modulation of light propagating through the optical waveguide, wherein the phase modulation unit includes:
a heater mechanism configured to heat the optical waveguide and
an RF electrode connected to the optical waveguide,
the optical waveguide has a ridge structure, and
the heater mechanism is formed on the core layer of the optical waveguide.

10. The semiconductor optical modulator according to claim 9, wherein the heater mechanism is disposed to be parallel to a longitudinal direction of the RF electrode, and has a resistance value of 300 Ω or more.

11. The semiconductor optical modulator according to claim 10, further comprising: a main line portion; and an RF phase modulation electrode including a plurality of T-shaped portions each connecting the main line portion and the RF electrode, wherein distances between the main line portion and the heater mechanism in a thickness direction and in a width direction are at least 5 μm or more.

12. The semiconductor optical modulator according to claim 11, wherein
the optical waveguide is formed on a semi-insulating substrate, and
has an n-i-p-n heterostructure including:
a first n-type semiconductor layer including at least one or more of an n-type semiconductor formed on the substrate,
a p-type semiconductor layer including at least one or more of a p-type semiconductor layer formed on the n-type semiconductor layer,
a core layer formed on the p-type semiconductor layer and including a non-doped semiconductor including an MQW layer, and
a second n-type semiconductor layer including at least one or more of an n-type semiconductor layer formed on the core layer; and
a thermal resistance of the p-type semiconductor is set higher than a thermal resistance of the non-doped semiconductor.

13. The semiconductor optical modulator according to claim 12, wherein a temperature of the optical waveguide of the phase modulation unit is adjusted for each wavelength under a same environmental temperature, and an operating temperature of the optical waveguide is higher toward a longer wavelength side.

14. The semiconductor optical modulator according to claim 13, wherein a design operating temperature of the semiconductor optical modulator is equal to or higher than a maximum temperature of an environmental temperature that at least an operation of the semiconductor optical modulator is required, and a calorific value of the heater mechanism is controlled by either current control or voltage control according to an operating wavelength, and under the same temperature, the calorific value of the heater is further increased during operation on a long wavelength side.

15. A semiconductor modulation device including the semiconductor optical modulator according to claim 11, the semiconductor modulation device comprising:
a driver IC including a temperature monitoring mechanism and is mounted adjacent to the semiconductor optical modulator in the same package, wherein
a calorific value of the heater mechanism of the semiconductor optical modulator is controlled by either current control or voltage control with reference to a temperature around the driver IC monitored by the temperature monitor mechanism of the driver IC, and the calorific value of the heater mechanism decreases as the temperature monitored by the temperature monitor mechanism increases when comparison is made at the same wavelength.

16. A semiconductor optical modulator comprising:
an optical waveguide having a structure that a lower cladding layer formed of at least one or more of an n-type semiconductor or a p-type semiconductor, a core layer formed of a non-doped semiconductor including an MQW layer, and an upper cladding layer formed of at least one or more of an n-type semiconductor or a p-type semiconductor are epitaxially grown in order on a semiconductor substrate; and
a phase modulation unit configured to perform phase modulation of light propagating through the optical waveguide, wherein
the phase modulation unit includes:
a heater mechanism configured to heat the optical waveguide and
an RF electrode connected to the optical waveguide,
the optical waveguide has a ridge structure or a high-mesa structure, and
the heater mechanism is formed on the substrate.

17. The semiconductor optical modulator according to claim 16, wherein the heater mechanism is disposed to be parallel to a longitudinal direction of the RF electrode, and has a resistance value of 300 Ω or more.

18. The semiconductor optical modulator according to claim 17, further comprising: a main line portion; and an RF phase modulation electrode including a plurality of T-shaped portions each connecting the main line portion and the RF electrode, wherein distances between the main line portion and the heater mechanism in a thickness direction and in a width direction are at least 5 μm or more.

19. The semiconductor optical modulator according to claim 18, wherein the optical waveguide is formed on a semi-insulating substrate, and
has an n-i-p-n heterostructure including:
a first n-type semiconductor layer including at least one or more of an n-type semiconductor formed on the substrate,
a p-type semiconductor layer including at least one or more of a p-type semiconductor layer formed on the n-type semiconductor layer,
a core layer formed on the p-type semiconductor layer and including a non-doped semiconductor including an MQW layer, and
a second n-type semiconductor layer including at least one or more of an n-type semiconductor layer formed on the core layer; and
a thermal resistance of the p-type semiconductor is set higher than a thermal resistance of the non-doped semiconductor.

20. The semiconductor optical modulator according to claim 18, wherein a temperature of the optical waveguide of the phase modulation unit is adjusted for each wavelength under a same environmental temperature, and an operating temperature of the optical waveguide is higher toward a longer wavelength side.

21. The semiconductor optical modulator according to claim 20, wherein a design operating temperature of the semiconductor optical modulator is equal to or higher than a maximum temperature of an environmental temperature that at least an operation of the semiconductor optical modulator is required, and a calorific value of the heater mechanism is controlled by either current control or voltage control according to an operating wavelength, and under the same temperature, the calorific value of the heater is further increased during operation on a long wavelength side.

22. A semiconductor modulation device including the semiconductor optical modulator according to claim 18, the semiconductor modulation device comprising:
a driver IC including a temperature monitoring mechanism and is mounted adjacent to the semiconductor optical modulator in the same package, wherein
a calorific value of the heater mechanism of the semiconductor optical modulator is controlled by either current control or voltage control with reference to a temperature around the driver IC monitored by the temperature monitor mechanism of the driver IC, and the calorific value of the heater mechanism decreases as the temperature monitored by the temperature monitor mechanism increases when comparison is made at the same wavelength.
